(19) United States
(12) Patent Application Publication
(10) Pub. No.: US 2018/0174122 A1
(43) Pub. Date: Jun. 21, 2018

(54) APPARATUS AND METHOD FOR COLLABORATIVE SHOPPING

(71) Applicant: Wal-Mart Stores, Inc., Bentonville, AR (US)

(72) Inventors: Todd D. Mattingly, Bentonville, AR (US); Donald R. High, Noel, MO (US); Nicholas Ray Antel, Springdale, AR (US); David Tovey, Rogers, AR (US); John J. O'Brien, Farmington, AR (US)

(21) Appl. No.: 15/842,521

(22) Filed: Dec. 14, 2017

Related U.S. Application Data
(60) Provisional application No. 62/434,765, filed on Dec. 15, 2016.

(51) Int. Cl. G06Q 20/12; G06Q 20/22; G06Q 20/40; G06Q 30/06; G06Q 20/20; G06Q 20/38

(52) U.S. Cl. CPC G06Q 20/12; G06Q 20/223; G06Q 20/4014; G06Q 20/0658; G06Q 20/206; G06Q 20/202; G06Q 20/3829; G06Q 30/0631

(57) ABSTRACT

Systems, apparatuses, and methods are provided herein for facilitating group shopping. A method for facilitating group shopping comprises authenticating a first user associated with a first user device and a second user associated with a second user device, providing a collaborative shopping user interface, relaying messages between the first user device and the second user device, receiving a purchase request from the first user device, facilitating, with the control circuit, an electronic peer-to-peer payment transfer of a digital currency from the second user device to the first user device, verifying that the electronic peer-to-peer payment transfer is completed, receiving a payment from the first user device comprising the digital currency, and outputting signaling to the POS system to process the purchase request in response to receiving the payment; and wherein the POS system is configured to process the purchase request using at least the payment.

### CROSS-REFERENCE TO RELATED APPLICATION

This application claims the benefit of the following U.S. Provisional Application No. 62/434,765 filed Dec. 15, 2016, which is incorporated herein by reference in its entirety.

### TECHNICAL FIELD

This invention relates generally to shopping services.

### BACKGROUND

Brick and mortar stores typically display a number of products for sale. A customer can browse and select items in the store and approach a checkout counter to purchase the selected items.

### BRIEF DESCRIPTION OF THE DRAWINGS

Disclosed herein are embodiments of apparatuses and methods for collaborative shopping. This description includes drawings, wherein:

FIG. 1 comprises a system diagram of an overall system in accordance with several embodiments;

FIG. 2 comprises a flow diagram of a method in accordance with several embodiments;

FIG. 3 comprises a process diagram of a method in accordance with several embodiments;

FIG. 4 comprises an illustration of blocks as configured in accordance with various embodiments of these teachings;

FIG. 5 comprises an illustration of transactions configured in accordance with various embodiments of these teachings;

FIG. 6 comprises a flow diagram in accordance with various embodiments of these teachings;

FIG. 7 comprises a process diagram as configured in accordance with various embodiments of these teachings;

FIG. 8 comprises an illustration of a delivery record configured in accordance with various embodiments of these teachings; and

FIG. 9 comprises a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for group shopping. In some embodiments, a system for facilitating group shopping comprises a user database, a product database, a point of sale (POS) system, a communication device configured to couple to two or more user devices, and a control circuit coupled to the user database, the product database, the POS system and the communication device. the control circuit being configured to authenticate a first user associated with a first user device and a second user associated with a second user device based on the user database, provide, via the communication device, a collaborative shopping user interface to the first user device and the second user device, the collaborative shopping user interface being configured to display product information associated with a plurality of products for sale based on information in the product database, the information comprising one or more of: a product image, a 3D model, a product description, a product price, product options, and a link to a product webpage, wherein at least some of the product information is viewable by both the first user and the second user via the first user device and the second user device using the collaborative shopping user interface, relay messages between the first user device and the second user device when the first user and the second user engage the collaborative shopping user interface, receive a purchase request from the first user device, facilitate an electronic peer-to-peer payment transfer of a digital currency from the second user device to the first user device, verify that the electronic peer-to-peer payment transfer is completed, receive a payment from the first user device comprising the digital currency, and output signaling to the POS system to process the purchase request in response to receiving the payment, and wherein the POS system is configured to process the purchase request using at least the payment.

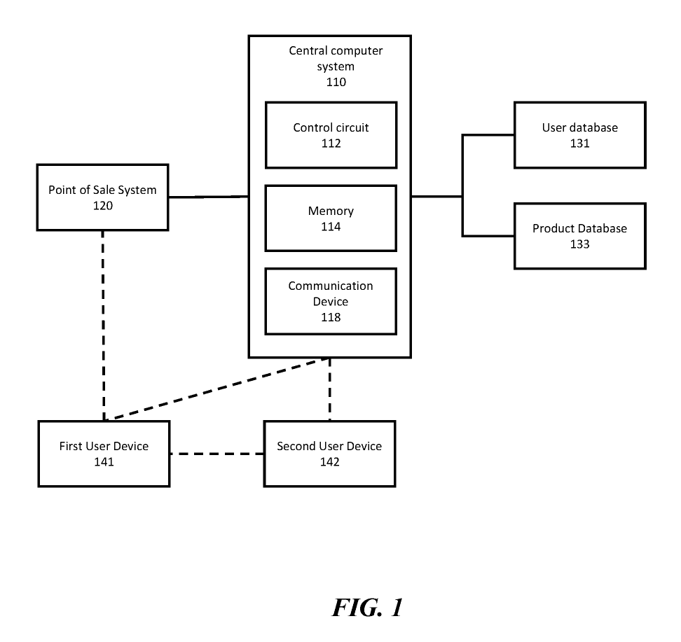

Referring now to FIG. 1, a collaborative shopping system is shown. The system comprises a central computer system 110, a user database 131, a product database 133, a point of sale system 120, a first user device 141, and a second user device 142.

The central computer system 110 comprises a control circuit 112, a memory 114, and a communication device 118. The control circuit 112 may comprise a processor, a microprocessor, a microcontroller, and the like and may be configured to execute computer readable instructions stored on a computer readable storage memory 114. The computer readable storage memory 114 may comprise volatile and/or non-volatile memory and have stored upon it a set of computer readable instructions which, when executed by the control circuit 112, causes the control circuit 112 to provide a collaborative shopping interface to the first user device 141 and the second user device 142. In some embodiments, the control circuit 112 may further be configured to facilitate and verify peer-to-peer electronic payment transfers between the first user device 141 and the second user device 142 for purchases made through the point of sale system 120. In some embodiments, the memory 114 may comprise a distributed database storing a digital currency blockchain and/or user authentication information.

The user database 131 may store user profiles for a plurality of users of a collaborative shopping user interface. In some embodiments, the user database 131 may store information such as user name, user location, user preference, user log-in credential, user social connections, user purchase history, etc. In some embodiments, the central computer system 110 may use the information stored in the user database 131 to authenticate users seeking to participate in the collaborative shopping user interface. In some embodiments, the central computer system 1100 may use the information stored in the user database 131 to configure collaborative the shopping user interface and/or products presented to the user in the user interface. For example, products displayed to a user may be selected and arranged based on their past shopping habits, preferences, demographic, etc. In some embodiments, at least a portion of the user database 131 may be implemented as a distributed database, a shared ledger, and/or a blockchain shared by the central computer system 110 and one or more user devices. In some embodiments, when a user seeks to log onto a collaborative shopping interface and/or join a collaborative shopping session with other users, one or more devices may use the distributed database to authenticate the user. In some embodiments, a user may be allowed into the system and/or a session only if consensus is reached among the devices sharing the distributed database and/or other participants of the collaborative shopping session.

The product database 133 may store product information associated with a plurality of products offered for sale via the collaborative shopping user interface and/or brick and mortar stores. In some embodiments, product information may comprise one or more of product image, 3D model, product description, product price, product options, link to a product webpage, product ingredients, product specification, product size, etc. In some embodiments, the product database 133 may further store product availability information at one or more store locations. While the user database 131 and the product database 133 are shown to be outside of the central computer system 110, in some embodiments, the user database 131 and the product database 133 may be implemented on the memory 114 and/or one or more other computer readable memory storage devices coupled to the control circuit 112 of the central computer system 110. In some embodiments, the user database 131 and the product database 133 may be accessed by the central computer system 110 via a wired or wireless data connection and/or via a network.

The POS system 120 comprises one or more devices configured to receive customer payment and/or process customer sales. In some embodiments, the POS system 120 may comprise staffed or self-checkout terminals in a brick and mortar store. In some embodiments, the POS system 120 may comprise an item scanner comprising one or more of a barcode scanner, a Radio Frequency Identification (RFID) scanner, an optical reader, a scale, a keypad, etc. In some embodiments, the POS system 120 may comprise a payment acceptor configured to receive one or more forms of payment methods such as a Near Field Communication (NFC) reader, a barcode scanner, an optical reader, a card reader, a cash receptor, a keypad, an IC chip reader, etc. In some embodiments, the POS system 120 may comprise a virtual checkout terminal comprising a user interface for the user to enter/select payment information via a user interface device such as the first user device 141 and the second user device 142. In some embodiments, the POS system 120 may comprise software modules within the collaborative shopping user interface provided by the central computer system 110. In some embodiments, the POS system 120 may be implemented via one or more of the central computer system 110, the first user device 141, and the second user device 142. In some embodiments, the POS system 120 may be configured to communicate with the central computer system 110 via a wired or wireless data connection and/or via a network. In some embodiments, the POS system 120 may be integrated with the central computer system 110 and share one or more hardware and software components.

The first user device 141 and the second user device 142 may generally comprise processor-based user interface devices. In some embodiments, the first user device 141 and the second user device 142 may each comprise a processor, a memory device, and one or more user input/output devices. In some embodiments, user input/output devices may comprise one or more of a display screen, a touch screen, a VR display, an AR display, one or more buttons, a keypad, a microphone, a speaker, a camera, a motion sensor, an eye movement sensor, etc. In some embodiments, the first user device 141 and the second user device 142 may comprise one or more of a smartphone, a mobile device, a head mounted display, a virtual reality (VR) display device, an augmented reality (AR) display device, a wearable device, a tablet computer, a laptop computer, a desktop computer, an internet of things (TOT) device, etc.

In some embodiments, the user devices may be configured to display a collaborative shopping user interface to a user. In some embodiments, the collaborate shopping user interface may comprise one or more of a software program, a mobile application, a cloud-based application, a web page, a web browser extension, and the like. In some embodiments, the collaborative shopping user interface may display product information provided via the central computer system 110 comprising one or more of a product image, a 3D model, a product description, a product price, product options, and a link to a product webpage. In some embodiments, the collaborative shopping user interface may comprise a virtual reality store presented as a virtual environment simulating a section of a store displaying a number of products for purchase. In some embodiments, the VR environment and representations of objects in the VR environment may be configured to respond to detected movements of the user. For example, a user may be able to pick up items in the VR store, inspect the item, and add items to a representation of a basket or a cart. In some embodiments, the first user and the second user may be represented as avatars in the virtual environment and may be able to converse and gesture to each other in the virtual environment. In some embodiments, the customer avatars may be customizable and/or may be based on the customer's real-life likeness. In some embodiments, users may collaboratively interact with representations of products in the virtual environment. For example, a user may pick up an item and hand it over to a second user to indicate their interest in that item. In some embodiments, a user may cause information related to a product to be displayed to one or more other users in a collaborative shopping session.

The first user device 141 and the second user device 142 may be configured to communicate with each other and/or the central computer system 110 via a wired and/wireless communication device. In some embodiments, the wireless communication device may comprise one or more of a Wi-Fi transceiver, a mobile data transceiver, a network adapter, a Bluetooth transceiver, an Internet modem, and the like. In some embodiments, the first user device 141 and the second user device 142 may be configured to communicate with each other and/or the central computer system 110 via a network such as the Internet. In some embodiments, at least the first user device 141 may further be configured to communicate with the POS system 120. In some embodiments, the first user device 141 may be configured to submit payment to the POS system 120 via one or more a network connection, a wireless communication device, an NCF signal, a RFID signal, an optically readable code, an authorization code, and the like. In some embodiments, the second user device 142 may comprise similar capabilities to communicate with the POS system 120.

While only two user devices are shown in FIG. 1, the central computer system 110 may simultaneously communicate with a plurality of user devices associated with a plurality of customers to provide collaborative shopping experiences. In some embodiments, three or more users may participate in a single collaborative shopping session. For example, three or four users may collectively select items to purchase and contribute to the cost of the purchase via the collaborative shopping user interface. In some embodiments, the system may allow a user to participate in a plurality of collaborative shopping sessions with different groups of people at the same time.

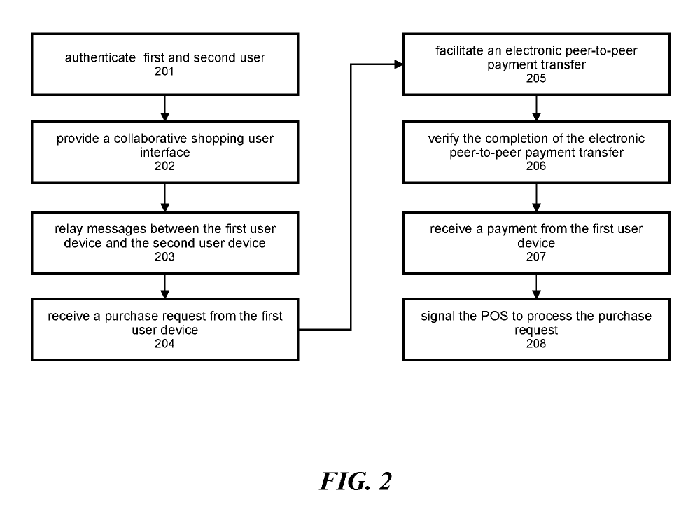

Referring now to FIG. 2, a method of providing collaborative shopping is shown. In some embodiments, the steps shown in FIG. 2 may be performed by a processor-based device such as one or more of a central computer system, a user device, and a point of sale system. In some embodiments, the steps in FIG. 2 may be performed by one or more of the central computer system 110, the POS system 120, the first user device 141, and the second user device 142 described with reference to FIG. 1 herein or similar devices.

In step 201, the system authenticates a first user associated with a first user device and a second user associated with a second user device. In some embodiments, the first user and the second user comprise customers of one of more of a brick-and-mortar store location, a virtual store, and an online store. For example, the first user may be an in-store shopper who communicates with a second user who is at home or sitting in a waiting area of the store. In another example, both users may comprise shoppers in a VR store. In some embodiments, the users may submit one or more of username, user password, a public encryption key, a security token, etc. to be authenticated. Generally, a public key refers to an encryption code in public key and/or asymmetric cryptography in which a cryptographic system uses a public key which may be disseminated widely and corresponding private key which is known only to the owner. In some embodiments, the authentication of the user devices may be based on information stored in a user database. In some embodiments, the user database may store information such as user name, user location, user preference, user log-in credential, user social connections, etc. In some embodiments, the user database may comprise an internal database maintained by the provider of the collaborative shopping interface. In some embodiments, the user database may comprise a distributed database shared by the provider and a plurality of users of the collaborative shopping interface. For example, user information may be encrypted into updates of a blockchain. Providers and/or other users may use the blockchain to verify the identity of a user seeking to log onto the collaborative shopping platform and/or join a collaborative shopping session with a group of users. In some embodiments, the central computer system may use a user database it maintains to authorize users when they log into the collaborative shopping platform and users in a collaborative shopping session may use a blockchain to verify the identities of other users seeking to join their session. In some embodiments, successful and/or unsuccessful authentication attempts may also be recorded into the database and/or the blockchain.

In step 202, the system provides a collaborative shopping user interface to the first user device and the second user device. In some embodiments, the collaborative shopping user interface may comprise one or more of a software program, a mobile application, a cloud-based application, a VR device application, an AR device application, a web page, a web browser extension, and the like. In some embodiments, users may initiate and/or join collaborative shopping sessions in the collaborative shopping user interface. For example, a customer may select one or more users on their contacts list to start a collaborative shopping session. In some embodiments, after a customer initiates a collaborative shopping session, the customer may be provided a session ID to give to others to join the session.

In some embodiments, the collaborative shopping user interface may display product information provided via a central computer system comprising one or more of a product image, a 3D model, a product description, a product price, product options, and a link to a product webpage. In some embodiments, the collaborative shopping user interface may comprise a virtual reality store presented as a virtual environment simulating a section of a store displaying a number of products for purchase. In some embodiments, the VR environment and representations of objects in the VR environment may be configured to respond to detected movements of the user. In some embodiments, the first and second users may be represented as avatars in the virtual environment and may be able to converse and gesture to each other in the virtual environment. In some embodiments, users may collaboratively interact with representations of products in the virtual environment. For example, a user may pick up an item and hand it over to a second user to indicate their interest in that item. In some embodiments, a user may cause information related to a product to be displayed to one or more other users in a collaborative shopping session.

In step 203, the system relays messages between the first user device and the second user device when the first user and the second user engage the collaborative shopping user interface. In some embodiments, messages may comprise text, images, voice, links, gestures, etc. In some embodiments, messages may comprise gestures and movements of an avatar in a virtual reality environment. In some embodiments, messages may comprise voice conversations in a VR or AR environment. In some embodiments, messages may comprise product information of products selected by the first user or the second user. For example, a user may send a selected product to another user in the collaborative shopping session through gesturing in the virtual environment or through a text chat and the selected product may be displayed to the second user. In some embodiments, the messages are shared among all participates of a collaborative shopping session. In some embodiments, users may send private messages to select members of a collaborative shopping session.

In some embodiments, messages may be routed through a central computer system or sent directly between the user devices through peer-to-peer communication. In some embodiments, messages between the user devices may be encrypted. In some embodiments, messages between user devices may be encrypted with the public key of the recipient under the asymmetric key encryption scheme. In some embodiments, the messages between user devices may be encrypted with a combined key under the Diffie-Hellman key exchange scheme. In some embodiments, messages between the first user device and the second user device may comprise updates to a blockchain. In some embodiments, an update to the blockchain may comprise authentication information associated with the author of a message that allows the author to control who can access and/or use a content of the message. For example, a message in a blockchain may be encrypted by a public key of the intended recipient of the message such that only the intended recipient is able to retrieve the message. In some embodiments, a blockchain update comprising the message may further specify the allowed usage of the content of the message and further updates of the blockchain would only be permitted if the usage rules are not violated. In some embodiments, a user device may be configured to authenticate the second user device and/or a message received from the second user device based on a public and/or a private key associated with the second user and/or the first user. In some embodiments, the collaborative shopping user interface may share the public keys of participants of a collaborative shopping session such that the participants can send each other secured messages through asymmetric key encryption and/or blockchain updates.

In step 204, the system receives a purchase request from a first user device. In some embodiments, the purchase request may comprise one or more items to purchase in the collaborative shopping session. In some embodiments, the purchase request may comprise a request to checkout with the content of a virtual or physical shopping cart or basket. For example, the first user may select a checkout button in a collaborative shopping interface to submit a purchase request. In another example, the user may approach a checkout terminal of an in-store POS system or a virtual reality store POS system with the contents of a shopping cart or basket. In some embodiments, the collaborative shopping user interface may allow participants of a session to vote on whether to conclude the session and submit a purchase request. In some embodiments, the purchase request may identify members of the collaborative shopping group who will contribute to the cost of the purchase. In some embodiments, the purchase request may further identify the amount each member is expected to contribute. In some embodiments, the system may evenly distribute the cost amount members by default.

In step 205, the system facilitates an electronic peer-to-peer payment transfer of a digital currency from the second user device to the first user device. In some embodiments, the electronic peer-to-peer payment is transferred without a central clearing house. In some embodiments, the electronic peer-to-peer payment comprises a crypto-currency transaction such as a bitcoin transaction. In some embodiments, the crypto-currency may comprise a digital currency backed by the provider of the collaborative shopping user interface and/or a seller of products provided via the collaborative shopping user interface. In some embodiments, the electronic peer-to-peer payment is facilitated by providing one or more of a link, a user identifier, a payment amount, and a payment authorization code to one or more of the first user device and the second user device. In some embodiments, when a purchase request is submitted, the collaborative user interface may provide the first user's public key to one or more other participants in the collaborative shopping session to transfer a payment to the first user. In some embodiments, the collaborative shopping user interface may determine the amount each participant should contribute and display the contribution amount to one or more participants of the collaborative shopping session. In some embodiments, the collaborative shopping user interface may be configured to send the transfer information (e.g. recipient ID and payment amount) to a third party electronic peer-to-peer payment application and/or cryptocurrency application such as the bitcoin wallet application. The customer can then complete the transfer in the third party application. In some embodiments, the transfer of the digital currency may comprise an update to a blockchain that records the transfer of a digital asset from the second user to the first user. In some embodiments, the transaction record or a copy of the record may be encrypted with a public key of the provider, the first user, and/or the second user. In some embodiments, the peer-to-peer payment transfer may comprise a conditional transfer. In some embodiments, the transferor may specify entities that the currency can be transferred to after the transferee receives the digital currency. In some embodiments, the transferee may be permitted to only use the digital currency to pay the provider/seller or return the digital currency to the transferor. In some embodiments, the transfer restrictions may be enforced collectively by nodes of the blockchain. In some embodiments, the digital currency transferred may be encrypted by public keys of the provider and the recipient such that only a transfer from the recipient to the provider could fully “unlock” the currency to be freely spendable. In some embodiments, the transfer may be configured to automatically revert back to the transferee after a set time has passed (e.g. 1 day, 1 week, etc.). In some embodiments, digital currency transfer and spending restrictions may be enforced by nodes of the blockchain, the payment transfer software program, and/or the collaborative shopping user interface software.

In step 206, the system verifies that the electronic peer-to-peer payment transfer is completed. In some embodiments, the system may check the recorded transactions in a cryptocurrency blockchain to verify that member(s) of the collaborative shopping session has transferred cryptocurrency to the person paying for the purchase. In some embodiments, the transaction record in the blockchain may be unencrypted or encrypted with a public key of the provider such that the provider may inspect the record of the transactions to verify that the payment transfer is completed. In some embodiments, the transaction may be verified when the blockchain update comprising the transaction is broadcasted to nodes of the blockchain, including the provider central computer system. In some embodiments, the transaction may be configured to be verified only if one or more subsequent blocks have been successfully added to the blockchain containing the transaction record. In some embodiments, the completion of the transaction may be verified by the first user when the electronic currency is added to the first user's account and/or becomes spendable by the first user. In some embodiments, step 206 may occur concurrently with step 207. For example, when the first user initiates a payment to the seller via a POS, the system may check the transfer history of the digital currency from the first user to verify that at least a portion of the payment was first transferred from the second user to the first user. In some embodiments, the providence of units of a digital currency may be recorded in and retrieved from a blockchain. In some embodiments, the system may further verify that the amount of the transfer matches the amount that each member of the collaborative shopping session agrees to contribute.

In step 207, the system receives a payment from the first user device. In some embodiments, the payment may comprise the digital currency. In some embodiments, the payment may comprise an electronic peer-to-peer payment transferred without a central clearing house. In some embodiments, the payment may comprise a crypto-currency transaction such as a bitcoin transaction. In some embodiments, the payment may be transferred through the collaborative shopping interface or a third party payment interface. In some embodiments, the payment may be received via a POS system such as an in-store or virtual checkout counter. In some embodiments, the POS system may comprise an optical code (e.g. barcode, QR code) reader, a user interface device (e.g. touch screen), a card scanner, a biometrics scanner, etc. for accepting digital currency from a customer. In some embodiments, the POS system may comprise the POS system 120 described with reference to FIG. 1 herein.

In step 208, the system outputs signaling to the POS system to process the purchase request in response to receiving the payment. In some embodiments, the system may signal the POS system to process the purchase request only if the completion of the transfer is verified in step 206. For example, the system may cause an in-store checkout counter to indicate whether the transferred has been verified before the cashier is allowed to accept the payment from the first user. In some embodiments, for a delivery or pickup order, the purchase may be placed on hold until the transfer is verified in step 206. In some embodiments, the purchase request may be processed only if participants of the collaborative shopping session has contributed their share such that not one member of the group is left footing the bill. In some embodiments, the paying customer may be able to select one or more members of the collaborative shopping session as “trusted” members whose payment transfer is not required to be verified prior to the purchase being processed. In some embodiments, in step 208, the purchase payment may further be recorded into the digital currency blockchain.

In some embodiments, one or more of steps 201-208 may be repeated multiple times before proceeding to the next step. For example, multiple messages may be relayed between the user devices in step 203 before a purchase request is received. In another example, step 206 may be repeated multiple times until the transaction is verified before the process proceeds to step 208. In some embodiments, multiple instances of steps 201-208 may be carried out simultaneously on a central computer system of a provider of the collaborative shopping interface and/or user devices.

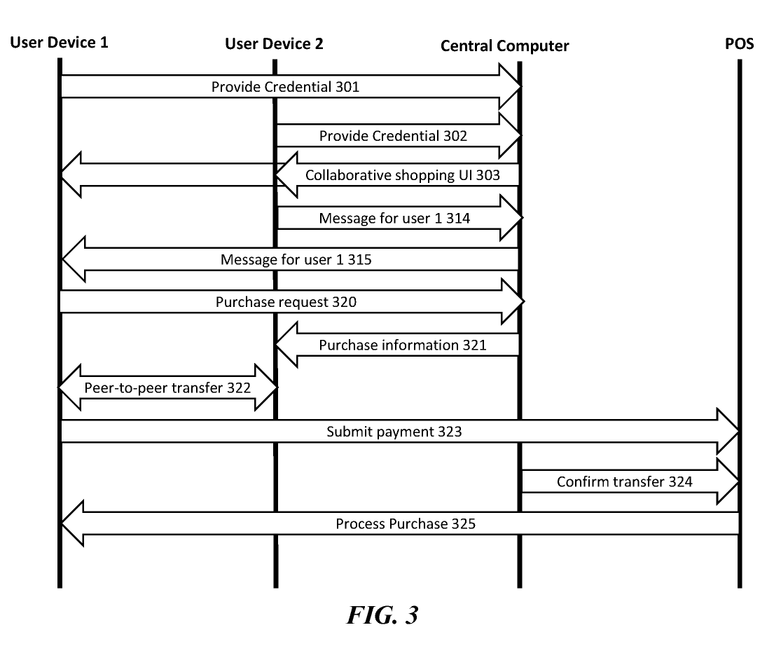

Referring now to FIG. 3A, a process of collaborative shopping is shown. In some embodiments, the user device 1, the user device 2, the central computer, and the POS system may each comprise a processor-based device comprising a control circuit, a memory, and communication device. In some embodiments, the user device 1, the user device 2, the central computer, and the POS system 120 may comprise the first user device 141, the second user device 142, the central computer system 110, and the POS system 120 described with references to FIG. 1 herein or similar devices.

In step 301, user device 1 provides credential to the central computer to join the collaborative shopping user interface. In step 302, user device 2 similarly provides user credential to the central computer. In some embodiments, the user credential may comprise one or more of username, user id, user password, a public key, a security token, and the like. In some embodiments, the user credential may be verified based on an internal user database of the central computer and/or based on a distributed database shared by the central computer and one or more user devices. In some embodiments, the user credentials in the distributed database may be encrypted with a public key of the central computer and/or other members of the collaborative shopping session such that only the authorized parties may access the personal information of the users for verification.

In step 303, after the user devices are authenticated, the central computer provides the collaborative shopping user interface to user device 1 and user device 2. In some embodiments, the collaborative shopping user interface may comprise one or more of a software program, a mobile application, a cloud-based application, a web page, a web browser extension, and the like. In some embodiments, users may initiate and/or join collaborative shopping sessions in the collaborative shopping user interface. For example, a customer may select one or more users on their contact list to start a collaborative shopping session.

In some embodiments, the collaborative shopping user interface may display product information provided via a central computer system comprising one or more of: a product image, a 3D model, a product description, a product price, product options, and a link to a product webpage. In some embodiments, the collaborative shopping user interface may comprise a virtual reality store comprising a virtual environment displaying a number of products for purchase. In some embodiments, the first user and the second user may be represented as avatars and may be able to converse and gesture to each other in the virtual environment. In some embodiments, users may collaboratively interact with representations of products in the virtual environment. For example, a user may pick up an item and give it to a second user to indicate their interest in that item. In some embodiments, one or more users in the collaborative shopping session may be permitted to add items to a collective virtual shopping cart to purchase. In some embodiments, the user interface may provide a voting interface for users in a session to vote on items they wish to purchase as a group.

In step 314, the user device 2 sends a message for user 1 while engaged in the collaborative shopping user interface. The message is first routed to the central computer and then sent to the user device 1 in step 315. In some embodiments, the message may comprise text, images, voice, links, gestures, etc. In some embodiments, the message may comprise gestures and movements of an avatar in a virtual reality environment. In some embodiments, messages may comprise voice conversations in a virtual reality environment. In some embodiments, messages may comprise product information of products selected by the first user or the second user. For example, a user may send a selected product to another user in the collaborative shopping session through gesturing in the virtual environment or through text chat, and the selected product may be displayed to the second user.

In some embodiments, instead of routing messages through the central computer as shown in FIG. 3, the user devices may be configured to carry out peer-to-peer messaging based on user IDs and/or publics keys exchanged via the collaborative shopping interface. In some embodiments, the collaborative shopping interface may share public keys associated with participants of a collaborative shopping session. The user devices may then use these public keys to carry out secure peer-to-peer communication via a blockchain or other messaging methods.

In step 320, user device 1 submits a purchase request to the central computer. In some embodiments, the purchase request may comprise one or more items selected for purchase by members of the collaborative shopping session. In some embodiments, the purchase request may comprise a request to checkout with the content of a virtual or physical shopping cart. For example, the first user may select a checkout button in a collaborative shopping interface. In another example, the user may approach a checkout terminal of an in-store POS system or a virtual reality store POS system.

In step 321, the central computer system provides the purchase information to user device 2 to facilitate a peer-to-peer payment. In some embodiments, the purchase information may comprise one or more of a user identifier associated with user device 1, a public encryption key associated with user device 1, a payment amount, a payment authorization code, product information, etc. Generally, the purchase information may convey details of the purchase of user device 2 and/or allow user device 2 to transfer payment to user device 1.

In step 322, the user device 1 and user device 2 performs electronic peer-to-peer transfer. In some embodiments, the electronic peer-to-peer payment is transferred without a central clearing house and/or the involvement of the central computer and the POS. In some embodiments, the electronic peer-to-peer payment comprises a crypto-currency transaction such as a bitcoin transaction. In some embodiments, the transfer of the digital currency may comprise an update to a blockchain that records the transfer of a digital asset from the second user to the first user. In some embodiments, the transaction record or a copy of the record may be encrypted by a public key of the provider, the first user, and/or the second user. In some embodiments, the peer-to-peer payment transfer may comprise a conditional transfer. For example, the transferor may specify entities that the currency can be transferred to after the transferee receives the digital currency. In some embodiments, the transferee may be permitted to only use the currency to pay the provider/seller or return the currency to the transferor. In some embodiments, the transfer restrictions may be enforced collectively by nodes of the blockchain. In some embodiments, the digital currency transferred may be encrypted by a public key of the central computer such that only a transfer to the central computer and/or POS system could fully “unlock” the currency to be freely spendable. In some embodiments, the digital currency may be configured to automatically revert back to the transferee after a set time has passed (e.g. 1 day, 1 week, etc.).

In step 323, user device 1 submits payment to the POS system. In some embodiments, the payment may be submitted via a checkout terminal in a brick and mortar and/or a virtual store. In some embodiments, the payment may comprise an electronic peer-to-peer payment is transferred without a central clearing house. In some embodiments, the payment may comprise a crypto-currency transaction such as a bitcoin transaction. In some embodiments, the crypto-currency may comprise a digital currency backed by the provider of the collaborative shopping user interface and/or a seller of products provided via the collaborative shopping user interface. In some embodiments, the payment may be transferred through the collaborative shopping interface or a third party payment interface. In some embodiments, the payment may be received via a POS system such as an in-store or virtual checkout counter. In some embodiments, the POS system may comprise an optical code (e.g. barcode, QR code) reader, a user interface device (e.g. touch screen), a card scanner, a biometrics scanner, etc. for accepting digital currency from a customer.

The POS system then waits for the central computer to confirm the payment from user device 2 to user device 1 in step 324 before processing the purchase in step 325. In some embodiments, the central computer may check the recorded transactions in a cryptocurrency blockchain to verify that one user has transferred cryptocurrency to another. In some embodiments, the transaction record in the blockchain may be encrypted by a public key of the provider such that the provider may inspect the record of the transactions to verify that the payment transfer is completed. In some embodiments, the transaction may be verified when the blockchain update comprising the transaction is broadcasted to nodes of the blockchain, including the provider central computer system. In some embodiments, the transaction may be configured to be verified only if one or more block has been successfully added to the blockchain containing the transaction record. In some embodiments, the first user device may be configured to provide the verification of the transfer to the POS system. In some embodiments, the completion of the transaction may be verified by the first user when the electronic currency becomes spendable by the first user. In some embodiments, when a digital currency is received from the first user, the system may check the transfer history of the digital currency to verify that at least a portion of the payment was first transferred from the second user to the first user. In some embodiments, the providence of units of digital currency may be recorded in and retrieved from a blockchain.

Once the peer-to-peer transfer is confirmed, the POS system processes the purchase in step 325. In some embodiments, an in-store checkout counter POS system may indicate whether the transferred has been verified before the cashier is allowed to accept the payment from the first user. In some embodiments, for a delivery or pickup order, the purchase order may be placed on hold until the transaction is confirmed in step 324. In some embodiments, the purchase request may be processed only if participants of the collaborative shopping session has contributed their share such that not one member of the group is left footing the bill. In some embodiments, in step 325, the purchase payment may further be recorded into for the digital currency blockchain. In some embodiments, the central computer and the POS system may be implemented on the same one or more processor based devices and share one or more memory and databases.

In some embodiments, one or more steps 301, 302, 303, 314, 315, 320, 321, 322, 323, 324, and 325 shown in FIG. 3 comprise an update to a blockchain shared by one or more of the central computer and user devices. In some embodiments, the sender of the step may broadcast the blockchain update to nodes of the blockchain and encrypt the messages with a public key of the intended recipient. For example, in step 321, the central computer may update the blockchain with purchase information that is encrypted with the public key associated the user device 2.

In some embodiments, a system for facilitating the social aspect of shopping is provided herein. In some embodiments, the system provides a user interface in which a customer can be linked through a feed/app to view the other customers' activities. The system may allow customers to communicate with each other through audio and/or text medium. In some embodiments, the medium of communication may be provided via a link. In some embodiments, customers may share additional information such as pricing information, product information, links to other information, etc. with each other. In some embodiments, a mobile application may be provided for customers to shop virtually with an avatar. The avatar of a customer may be created for shopping purposes and may be provided to customers participating in a social shopping session. Customers may view other customers' avatars through a collaborative shopping mobile application. In some embodiments, product information being viewed by an avatar may also be visible to other customers of the collaborative shopping session and the other customer can provide suggestions and/or recommendations based on what they see.

In some embodiments, a collaborative shopping user interface platform provides users with security and privacy via peer-peer connection and communication. In some embodiments, a collaborative shopping platform is provided in which customers may be connected via a feed/application that authenticates and encrypts the users by way of blockchain. In some embodiments, customers can communicate with each other through audio, text, and/or video and the medium of communication may be provided via a link encrypted through blockchain. In some embodiments, customers may share additional information, such as pricing information, product information, snapshots, pictures, videos, links to other information, etc. with each other. In some embodiments, an application may be provided for customers to shop virtually with an avatar. In some embodiments, an avatar of a customer may be created for shopping purposes and may be associated with each customer participating in a social shopping session. In some embodiments, customer avatars and other personal details may be displayed to other authenticated users through the collaborative shopping user interface application. In some embodiments, users may customize permissions on who can view their personal information. In some embodiments, product information viewed by an avatar may be visible to other customers of the social shopping session based on authentication and permissions configurations.

In some embodiments, customer profile information comprising customer partialities, preferences, values, affinity, and/or aspirations may be used to provide categorization of products and services throughout the collaborative shopping experience. In some embodiments, customer profile information may also be used to provide categorization of personal details of the customer, such as profile information, census information, location information, values, affinities, etc.

In some embodiments, blockchain may be used to authenticate users in the peer-peer communication. In some embodiments, blockchain may also be used to provide security and cloaking of the customer's personal information, profile, IP address, financial information, etc. In some embodiments, customers may also be able to exchange digital currency through the blockchain system.

In some embodiments, the user devices may use a private/public key encryption system for message authentication. In some embodiments, when User A sends a message to User B, the message is encrypted with the public key of User B such that User B may access the content from User A using their private key. In some embodiments, key authentication may comprise only private, only public, or a combination of public and private key authentication.

In some embodiments, the system may include a profile engine configured to filter messages by profile settings where the user has denoted specific keys for viewing from other users. In some embodiments, the profile engine may function like an spam email filter with the added ability to access the public ledger of contacts and grant access and permissions for sending messages. In some embodiments, users can also search for other users using standard information (name, phone number, etc.) or by way of a public key, privately held key, temporary key, business contact key, etc.

In some embodiments, private/public key system may be used in authenticated peer-to-peer communication. In some embodiments, when a user communicates with or adds another user to their social network, a user may compare the public key from the public ledger system to the other user's submitted public key. The system may provide transparency to users regarding who they contact, add, message, and communicate with while providing controls for transparency and authentication. In some embodiments, users may choose to block other users or grant access to specific areas of information to different users.

In some embodiments, a blockchain may be used for messaging. Messages recorded in a blockchain may be used to track and organize who is who, and what came from who and when. In some embodiments, a blockchain update comprising a message may comprise information such as: the message, time, date, location, public key, access controls, and who may delete, modify, forward, reply, etc. In some embodiments, the messages may be encrypted in the database and can be decrypted only with the author and/or the recipient's private key.

In some embodiments, the system allows users to control what happens to a message when it is sent to another user. For example, the recipient's ability to forward or reply to a message may be restricted. In some embodiments, the restriction may be specified in the block comprising the message. In some embodiments, the author may view who the information has been shared with based on the blockchain records. In some embodiments, the author may be allowed to shutdown, delete, or block the information at any time. In some embodiments, if User A sends a message to User B, User B may be the only one with access. At a later time, User A may grant other users access to the content shared with User B. At a later time, User A may terminate all access to the given block of information making the message is no longer viewable, shareable, etc. In some embodiments, the access restriction of messages may be enforced through nodes of the blockchain and/or through the software of the collaborative shopping user interface.

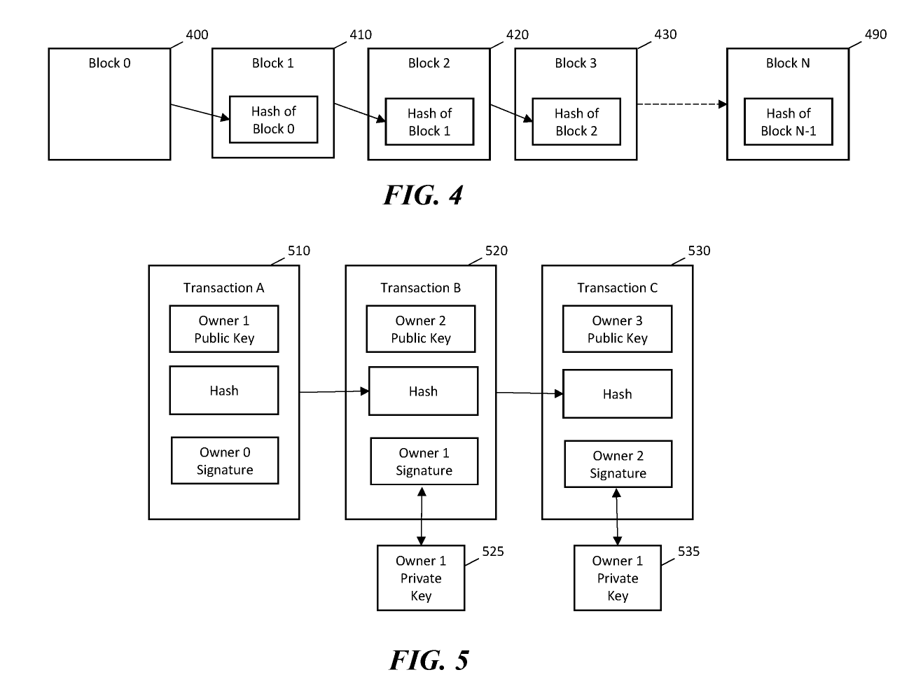

Descriptions of some embodiments of blockchain technology are provided with reference to FIG. 4-9 herein. In some embodiments of the invention described above, blockchain technology may be utilized to record peer-to-peer digital asset transfers, peer-to-peer user authentication, and peer-to-peer messaging. One or more of a central computer system, a POS system, and user device may comprise a node in a distributed blockchain system storing the blockchain record. Updates to the blockchain may comprise a transaction records, peer-to-peer messages, and/or a user profile information, and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 4, an illustration of a blockchain according to some embodiments is shown. In some embodiments, a blockchain comprises a hash chain or a hash tree in which each block added in the chain contains a hash of the previous block. In FIG. 4, block 0 400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

Now referring to FIG. 5, an illustration of blockchain based transactions according to some embodiments is shown. In some embodiments, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 220. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

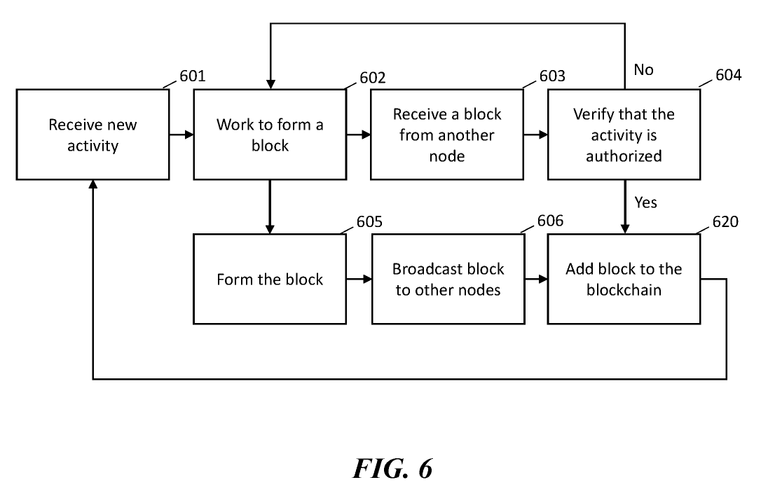

Now referring to FIG. 6, a flow diagram according to some embodiments is shown. In some embodiments, the steps shown in FIG. 6 may be performed by a processor-based device, such as a computer system, a server, a distributed server, a timestamp server, a blockchain node, and the like. In some embodiments, the steps in FIG. 6 may be performed by one or more of the nodes in a system using blockchain for record keeping.

In step 601, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 601. In step 602, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In some embodiments, in a system with incentive features, the first node to form a block may be permitted to add incentive payment to itself in the newly formed block. In step 620, the node then adds the block to its copy of the blockchain. In the event that the node receives a block formed by another node in step 603 prior to being able to form the block, the node works to verify that the activity recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

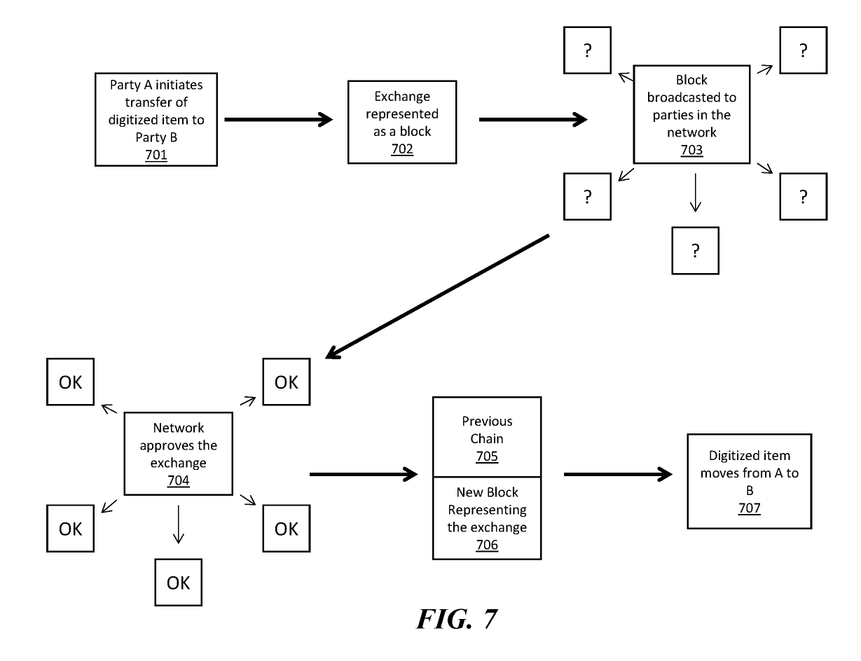

Now referring to FIG. 7, a process diagram a blockchain update according to some implementations in shown. In step 701, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 702, the exchange initiated in step 701 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 703, the block is broadcasted to parties in the network. In step 704, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 706 representing the exchange is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the digitized item is moved from party A to party B.

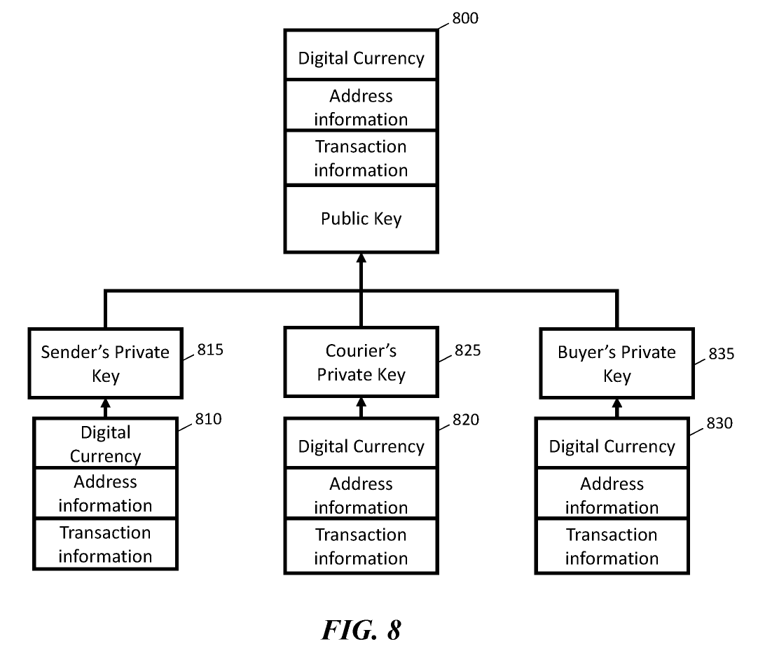

Now referring to FIG. 8, a diagram of a blockchain according to some embodiments in shown. FIG. 8 comprises an example of an implementation of a blockchain system for delivery service record keeping. The delivery record 800 comprises digital currency information, address information, transaction information, and a public key associated with one or more of a sender, a courier, and a buyer. In some embodiments, nodes associated the sender, the courier, and the buyer may each store a copy of the delivery record 810, 820, and 830 respectively. In some embodiments, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 8, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of a physical asset. With the distributed database and peer-to-peer verification of a blockchain system, the sender, the courier, and the buyer can each have confidence in the authenticity and accuracy of the delivery record stored in the form of a blockchain.

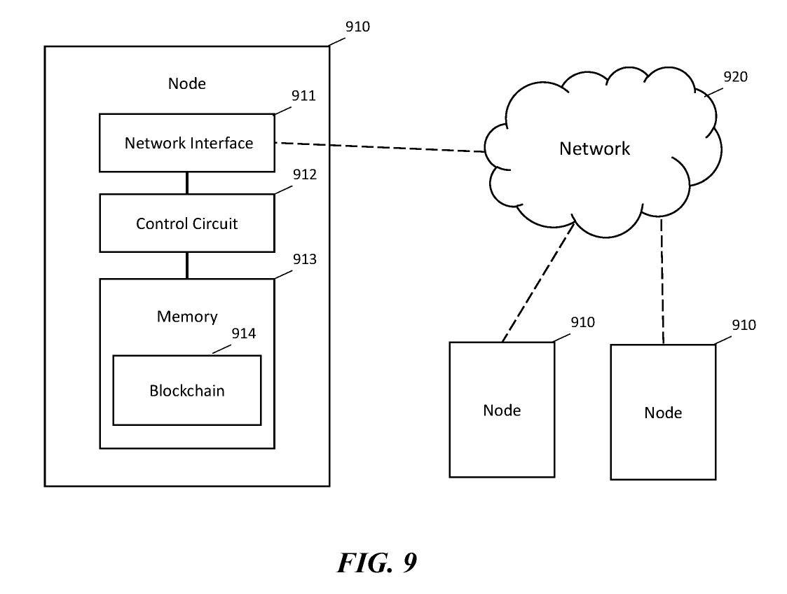

Now referring to FIG. 9, a system according to some embodiments is shown. A distributed blockchain system comprises a plurality of nodes 910 communicating over a network 920. In some embodiments, the nodes 910 may comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. In some embodiments, the control circuit 912 may further be configured to extend the blockchain 914 by processing updates to form new blocks for the blockchain 914. Generally, each node may store a version of the blockchain 914, and together, may form a distributed database. In some embodiments, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. In some embodiments, the network 920 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide a proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that use one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In one embodiment, a system for facilitating group shopping comprises a user database, a product database, a point of sale (POS) system, a communication device configured to couple to two or more user devices, and a control circuit coupled to the user database, the product database, the POS system and the communication device. the control circuit being configured to authenticate a first user associated with a first user device and a second user associated with a second user device based on the user database, provide, via the communication device, a collaborative shopping user interface to the first user device and the second user device, the collaborative shopping user interface being configured to display product information associated with a plurality of products for sale based on information in the product database, the information comprising one or more of: a product image, a 3D model, a product description, a product price, product options, and a link to a product webpage, wherein at least some of the product information is viewable by both the first user and the second user via the first user device and the second user device using the collaborative shopping user interface, relay messages between the first user device and the second user device when the first user and the second user engage the collaborative shopping user interface, receive a purchase request from the first user device, facilitate an electronic peer-to-peer payment transfer of a digital currency from the second user device to the first user device, verify that the electronic peer-to-peer payment transfer is completed, receive a payment from the first user device comprising the digital currency, and output signaling to the POS system to process the purchase request in response to receiving the payment, and wherein the POS system is configured to process the purchase request using at least the payment.

In one embodiment, a method for facilitating group shopping comprises authenticating, with a control circuit coupled to a user database, a product database, a point of sale (POS) system, and a communication device, a first user associated with a first user device and a second user associated with a second user device based on the user database, providing, with the control circuit and via the communication device, a collaborative shopping user interface to the first user device and the second user device, the collaborative shopping user interface being configured to display product information associated with a plurality of products for sale based on information in the product database, the information comprising one or more of: a product image, a 3D model, a product description, a product price, product options, and a link to a product webpage, wherein at least some of the product information is viewable by both the first user and the second user via the first user device and the second user device using the collaborative shopping user interface, relaying messages between the first user device and the second user device when the first user and the second user engage the collaborative shopping user interface, receiving a purchase request from the first user device, facilitating, with the control circuit, an electronic peer-to-peer payment transfer of a digital currency from the second user device to the first user device, verifying that the electronic peer-to-peer payment transfer is completed, receiving a payment from the first user device comprising the digital currency, and outputting, with the control circuit, signaling to the POS system to process the purchase request in response to receiving the payment, and wherein the POS system is configured to process the purchase request using at least the payment.

In one embodiment, an apparatus for facilitating group shopping comprises a non-transitory storage medium storing a set of computer readable instructions, and a control circuit coupled to a user database, a product database, a point of sale (POS) system, and a communication device, the control circuit being configured to execute the set of computer readable instructions which causes to the control circuit to: authenticate with a first user associated with a first user device and a second user associated with a second user device based on the user database, provide, via the communication device, a collaborative shopping user interface to the first user device and the second user device, the collaborative shopping user interface being configured to display product information associated with a plurality of products for sale based on information in the product database, the information comprising one or more of: a product image, a 3D model, a product description, a product price, product options, and a link to a product webpage, wherein at least some of the product information is viewable by both the first user and the second user via the first user device and the second user device using the collaborative shopping user interface, relay messages between the first user device and the second user device when the first user and the second user engage the collaborative shopping user interface, receive a purchase request from the first user device, facilitate an electronic peer-to-peer payment transfer of a digital currency from the second user device to the first user device, verify that the electronic peer-to-peer payment transfer is completed, receive a payment from the first user device comprising the digital currency, and output signaling to the POS system to process the purchase request in response to receiving the payment, and wherein the POS system is configured to process the purchase request using at least the payment.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for facilitating group shopping, comprising:
a user database;
a product database;
a point of sale (POS) system comprising an optical code reader;
a communication device configured to couple to two or more user devices; and
a control circuit coupled to the user database, the product database, the POS system and the communication device, and configured to:
authenticate a first user associated with a first user device and a second user associated with a second user device based on the user database;
provide, via the communication device, a collaborative shopping user interface to the first user device and the second user device, the collaborative shopping user interface being configured to display product information associated with a plurality of products for sale based on information in the product database, the information comprising one or more of: a product image, a 3D model, a product description, a product price, product options, and a link to a product webpage, wherein at least some of the product information is viewable by both the first user and the second user via the first user device and the second user device using the collaborative shopping user interface;
relay messages between the first user device and the second user device when the first user and the second user engage the collaborative shopping user interface;
receive a purchase request from the first user device;
facilitate an electronic peer-to-peer payment transfer of a digital currency from the second user device to the first user device, wherein the peer-to-peer payment transfer is recorded on a distributed ledger;
verify that the electronic peer-to-peer payment transfer is completed via the distributed ledger;
receive a payment from the first user device comprising the digital currency via the optical code reader of the POS system; and
output signaling to the POS system to process the purchase request in response to receiving the payment;
wherein the POS system is configured to process the purchase request using at least the payment.

2. The system of claim 1, wherein the electronic peer-to-peer payment is transferred without a central clearing house.

3. The system of claim 1, wherein the electronic peer-to-peer payment is facilitated by providing one or more of a link, a user identifier, a payment amount, and a payment authorization code to one or more of the first user device and the second user device.

4. The system of claim 1, wherein the electronic peer-to-peer payment comprises a crypto-currency transaction.

5. The system of claim 1, wherein the first user and the second user comprise customers of one of more of a brick-and-mortar store location, a virtual store, and an online store.

6. The system of claim 1, wherein the first user and the second user are represented as avatars in a virtual environment simulating a section of a virtual store displaying a number of products for purchase.

7. The system of claim 1, wherein the messages between the first user device and the second user device comprises product information of products selected by the first user or the second user.

8. The system of claim 1, wherein the messages between the first user device and the second user device comprises updates to a blockchain stored on a plurality of user devices.

9. The system of claim 8, wherein an update to the blockchain comprise authentication information associated with an author of a message that allows the author to control who can access and/or use a content of the message.

10. The system of claim 1, wherein the first user device is configured to authenticate the second user device and/or a message received from the second user device based on a public key stored in a distributed database.

11. A method for facilitating group shopping, comprising:
authenticating, with a control circuit coupled to a user database, a product database, a point of sale (POS) system, and a communication device, a first user associated with a first user device and a second user associated with a second user device based on the user database;
providing, with the control circuit and via the communication device, a collaborative shopping user interface to the first user device and the second user device, the collaborative shopping user interface being configured to display product information associated with a plurality of products for sale based on information in the product database, the information comprising one or more of: a product image, a 3D model, a product description, a product price, product options, and a link to a product webpage, wherein at least some of the product information is viewable by both the first user and the second user via the first user device and the second user device using the collaborative shopping user interface;
relaying messages between the first user device and the second user device when the first user and the second user engage the collaborative shopping user interface;
receiving a purchase request from the first user device;
facilitating, with the control circuit, an electronic peer-to-peer payment transfer of a digital currency from the second user device to the first user device, wherein the peer-to-peer payment transfer is recorded on a distributed ledger;
verifying that the electronic peer-to-peer payment transfer is completed via the distributed ledger;
receiving a payment from the first user device comprising the digital currency via a optical code reader of the POS system; and
outputting, with the control circuit, signaling to the POS system to process the purchase request in response to receiving the payment;
wherein the POS system is configured to process the purchase request using at least the payment.

12. The method of claim 11, wherein the electronic peer-to-peer payment is transferred without a central clearing house.

13. The method of claim 11, wherein the electronic peer-to-peer payment is facilitated by providing one or more of a link, a user identifier, a payment amount, and a payment authorization code to one or more of the first user device and the second user device.

14. The method of claim 11, wherein the electronic peer-to-peer payment comprises a crypto-currency transaction.

15. The method of claim 11, wherein the first user and the second user comprise customers of one of more of a brick-and-mortar store location, a virtual store, and an online store.

16. The method of claim 11, wherein the first user and the second user are represented as avatars in a virtual environment simulating a section of a virtual store displaying a number of products for purchase.

17. The method of claim 11, wherein the messages between the first user device and the second user device comprises product information of products selected by the first user or the second user.

18. The method of claim 11, wherein the messages between the first user device and the second user device comprises updates to a blockchain stored on a plurality of user devices.

19. The method of claim 18, wherein an update to the blockchain comprise authentication information associated with an author of a message that allows the author to control who can access and/or use a content of the message.

20. An apparatus for facilitating group shopping, comprising:
a non-transitory storage medium storing a set of computer readable instructions; and
a control circuit coupled to a user database, a product database, a point of sale (POS) system, and a communication device, the control circuit being configured to execute the set of computer readable instructions which causes to the control circuit to:
authenticate with a first user associated with a first user device and a second user associated with a second user device based on the user database;
provide, via the communication device, a collaborative shopping user interface to the first user device and the second user device, the collaborative shopping user interface being configured to display product information associated with a plurality of products for sale based on information in the product database, the information comprising one or more of: a product image, a 3D model, a product description, a product price, product options, and a link to a product webpage, wherein at least some of the product information is viewable by both the first user and the second user via the first user device and the second user device using the collaborative shopping user interface;
relay messages between the first user device and the second user device when the first user and the second user engage the collaborative shopping user interface;
receive a purchase request from the first user device;
facilitate an electronic peer-to-peer payment transfer of a digital currency from the second user device to the first user device, wherein the peer-to-peer payment transfer is recorded on a distributed ledger;
verify that the electronic peer-to-peer payment transfer is completed via the distributed ledger;
receive a payment from the first user device comprising the digital currency via the optical code reader of the POS system; and
output signaling to the POS system to process the purchase request in response to receiving the payment;
wherein the POS system is configured to process the purchase request using at least the payment.
